(19) United States
(12) Patent Application Publication
(10) Pub. No.: US 2026/0058948 A1
(43) Pub. Date: Feb. 26, 2026

(54) SYSTEMS AND METHODS FOR ARTIFICIAL INTELLIGENCE-BASED USER VERIFICATION

(71) Applicant: EyeDentify Oy, Tampere (FI)

(72) Inventors: Pooya SAKETI, Rochestown (IE); Padraig HUGHES, Berrings (IE); Emmanuel TANGAS, Sammamish, WA (US)

(21) Appl. No.: 19/306,554

(22) Filed: Aug. 21, 2025

(30) Foreign Application Priority Data
Aug. 23, 2024 (GB) 2412409.1

(51) Int. Cl. H04L 9/40; G06V 10/774; G06V 40/18; G06V 40/20; G06V 40/40

(52) U.S. Cl. CPC H04L 63/0861; G06V 10/774; G06V 40/197; G06V 40/20; G06V 40/45

(57) ABSTRACT

Embodiments relate to a computer-implemented method for identification of image characteristics. The method includes analysing the contents of a plurality of image frames using one or more artificial intelligence (AI) models trained on historical data including human eye-tracking data. The analysing includes identifying one or more characteristics associated with eye-tracking data of a subject in the image frames, and comparing the one or more characteristics with historical data on which the AI models are trained to determine a degree of similarity between the characteristics and the historical data. The state of a first user electronic device or a second electronic device is changed based on a result of the comparison of characteristics with the historical data. Embodiments also relate to machine-readable information printed on a lens of the first electronic device or a contact lens in conjunction with the eye-tracking data analysis, as an additional security layer.

### CROSS-REFERENCE TO RELATED APPLICATIONS

This application claims priority United Kingdom Patent Application No. GB 2412409.1 filed on Aug. 23, 2024, which is incorporated by reference herein in its entirety.

### FIELD OF THE INVENTION

The present invention relates to systems and methods for verifying the identity, or particular identity-related characteristics, of users of electronic devices. In particular, the invention relates to methods and systems for using artificial intelligence (AI) algorithms to analyse eye-tracking characteristics in image frames captured by an electronic device.

### BACKGROUND

Modern ‘deepfake’ AI technologies produce highly realistic outputs, including images, videos, and audio outputs, making detection by humans or algorithms increasingly difficult. The state-of-the-art in deepfake detection involves the use of advanced machine learning (ML) models, large datasets, and multi-modal analysis techniques.

AI's monthly exponential improvements compound the annual risk of criminal and social harm from deepfake activity, including threats to the global financial banking system, election integrity, and to protecting the personal safety of adults and children from pornography and sexual predators, military deepfake hacks, and synthetic social media content to name just a few.

Deepfake algorithms often struggle to replicate natural eye behaviour, making eyes a valuable focus for detection. Current state of the art deepfake detection is either performed offline on pictures and videos, or if they are online they are limited to non-continuous techniques like iris scanning, which can't authenticate between people and bots in real time. This is because iris scanning requires particularly high resolution imaging from a very close working distance that will block the visual pathway. As a result, it is disruptive to the users' normal workflow. In addition, iris scanning is a static measurement that lakes dynamic characteristics that change over time.

In addition to the deepfake detection issues highlighted above, detecting the age of users accessing online content is an unmonitored manual process that relies entirely on user input and trust. For example, a user may be required to respond to a pop-up on a website confirming they are above a certain age in order to access the contents of the website, such as a tobacco or alcohol sales website requiring the user to be over an age related to local laws around the sale of these goods. There is no automatic age detection technology for virtual digital environments, and with the increasing prevalence and sophistication of deepfake technology on the rise, any useful age detection technology must be able to distinguish between real and synthetic subjects in images and videos.

Therefore, new technologies are required for deepfake prevention that are real-time and continuous.

### SUMMARY

According to a first aspect of the present disclosure there is provided a computer-implemented method for identification of image characteristics, the method comprising: analysing the contents of a plurality of image frames using one or more artificial intelligence (AI) models trained on historical data including human eye-tracking data, wherein the analysing at least comprises: identifying one or more characteristics associated with eye-tracking data of a subject in the image frames, and comparing said one or more characteristics with historical data on which the AI model(s) are trained in order to determine a degree of similarity between the characteristic(s) and the historical data; and changing a state of a first user electronic device or a second electronic device, at least in part based on a result of the comparison of the one or more characteristics with the historical data.

Optionally, the method further comprises displaying, in the display of the first user electronic device, one or more visual stimuli.

Optionally, the method further comprises capturing, by an image capture device of the first user electronic device, the plurality of image frames.

Optionally, the method further comprises capturing, by an image capture device of the first user electronic device, the plurality of image frames, and repeating the steps of capturing and analysing in order to determine if one or more characteristics associated with eye-tracking data of the subject have changed.

Optionally, the method further comprises changing the state of the first user electronic device based on determining that the result of the comparison has changed after repeating.

Optionally, changing the state of the first user electronic device comprises preventing access to a software application on the first user electronic device based on the one or more characteristics not matching the historical data to within a pre-defined threshold. The pre-defined threshold may optionally comprise a feature importance set at about 80% but not limited to 80%.

Optionally, changing the state of the first user electronic device comprises admitting access to a software application on the first user electronic device based on the one or more characteristics matching the historical data to within a pre-defined threshold.

Optionally, the second user electronic device is in media communication with the first electronic device, and wherein changing the state of the second user electronic device comprises providing a notification to the second user electronic device.

Optionally, the one or more characteristics comprises a Fixation Duration, a Fixation Count, a Saccade, a Pupil Diameter, a Gaze Path, a heat map, an Area of Interest (AOI), a Latency, a Return Visit, a Pupil Dilation, and/or a Blink Rate.

Optionally, data associated with the analysed, captured image frames is provided to the AI model(s) for further training.

Optionally, the analysing the contents of at least some of the image frames further comprises a determination of an age or age range of the subject based on the result of the comparison of the one or more characteristics with the historical data.

Optionally, the analysing the contents of at least some of the image frames further comprises a determination if the subject matches a pre-recorded identity of a person based on the result of the comparison of the one or more characteristics with the historical data.

Optionally, the analysing the contents of at least some of the image frames comprises determining whether or not the subject is a real human based on the result of comparing said one or more characteristic with historical data on which the AI model(s) are trained.

Optionally, the method further comprises identifying the presence of machine readable information on a lens of the image capture device, wherein the machine readable information encodes personal identifying information (PII).

Optionally, comparing the one or more characteristics with historical data comprises comparing the PII against the one or more characteristics determined from the image frame(s) in order to determine if the identity of the human subject matches the identity of a person in the PII.

Optionally, the PII comprises one or more biological characteristics of the person.

Optionally, the biological characteristics of the person include eye-tracking biometric data associated with the person.

Optionally, the method further comprises identifying in the image frames the presence of machine readable information on a contact lens worn by the human subject, wherein the machine readable information encodes personal identifying information (PII).

Optionally, the method further comprises comparing the PII against the one or more characteristics determined from the image frame(s) in order to determine if the identity of the human subject matches the identity of the person.

Optionally, the method further comprises adjusting one or more image enhancement settings in order to enhance detection of machine readable information.

According to a further aspect of the present disclosure there is provided a computer-implemented method for identification of image characteristics, comprising: analysing the contents of a plurality of image frames using one or more artificial intelligence (AI) models trained on historical data, wherein the analysing at least comprises: identifying the presence of a subject in the image frames, identifying in the image frames the presence of machine readable information on a contact lens worn by the subject, wherein the machine readable information encodes personal identifying information (PII), and comparing the PII against an identity record for a person associated with the user electronic device; changing a state of the user electronic device based on the result of the comparison of the PII against the identity record for the person associated with the electronic device.

According to a further aspect of the present disclosure there is provided a computer-implemented method for identification of image characteristics, comprising: analysing the contents of a plurality of image frames using one or more artificial intelligence (AI) models trained on historical data, wherein the analysing at least comprises: identifying the presence of a subject in the image frames, identifying in the image frames the presence of machine readable information on a contact lens worn by the subject, wherein the machine readable information encodes personal identifying information (PII), identifying the presence of machine readable information on a lens of the image capture device, wherein the machine readable information encodes personal identifying information (PII) corresponding to a person associated with the user electronic device, and comparing the PII encoded on the contact lens with the PII encoded on the lens of the image capture device in order to determine if the identity of the subject matches the identity of the person associated with the user electronic device; changing a state of the user electronic device based on the result of the comparison of the PII encoded on the contact lens with the PII encoded on the lens of the image capture device.

Optionally the method further comprises comparing the PII encoded on the contact lens and the PII encoded on the lens of the image capture device with the record of ownership identity for the user electronic device.

According to a further aspect of the present disclosure there is provided computer readable media storing instructions thereon that, when executed by one or more processors, cause the processors to carry out any of the methods disclosed herein.

According to a further aspect of the present disclosure there is provided a system for identification of image characteristics implementing any of the methods disclosed herein, comprising a user electronic device comprising an image capture device configured for capturing image frames, and one or more processors configured to carry out any of the methods disclosed herein.

### BRIEF DESCRIPTION OF THE DRAWINGS

FIG. 1 is a flow diagram illustrating an exemplary method for the identification of image characteristics.

FIG. 2 is an algorithmic flow diagram illustrating a series of security gates that can be implemented in embodiments of exemplary method for the identification of image characteristics.

FIGS. 3-5 are flow diagrams illustrating exemplary methods for the identification of image characteristics.

FIG. 6 is an algorithmic flow diagram illustrating a series of security gates that can be implemented in embodiments of exemplary method for the identification of image characteristics.

FIG. 7 is a block diagram illustrating an exemplary system for implementing methods of the present disclosure.

### DETAILED DESCRIPTION

The present disclosure provides verification systems and methods that can be used in varying combinations to detect biometric or physiological patterns or artefacts which are consistent or inconsistent cues to the identity or age profile of an individual, in order to identify or verify real human existence.

The system includes software, and optionally hardware, components. Where the system includes hardware components, these components may be suitably configured for one or more of detection, processing, and classification of the biometric markers (“biomarkers”) and physiological features. In preferred embodiments, the biomarkers and physiological features include eye-tracking characteristics. The biomarkers data can be stored in the cloud, on a distributed network such as a blockchain, in a data centre, or on a user electronic device such as a phone, a tablet, a computer device, an AR/VR device, a webcam, or a smart watch.

Unlike existing detection methods such as iris scanning, the detection methods of the present invention do not gather, or have access to, unnecessary additional biometric or physiological information on the human thereby avoiding privacy and growing regulatory challenges. The use of AI models for iris scanning in real-time can also lead to a “combinatorial explosion” resulting from the need to compare a unique, high-entropy iris pattern against a vast number of other unique patterns for identification in a high-resolution image dataset. In contrast, other eye-tracking parameters are found to require less computational power to analyse and do not demand the same resolution and lighting conditions necessary for iris scanning.

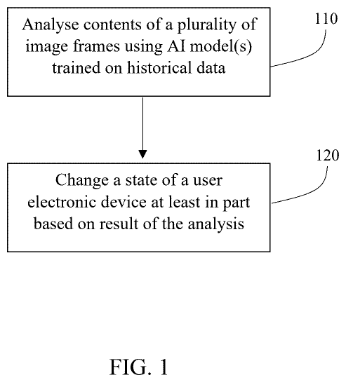

Referring to FIG. 1, a computer-implemented for the identification of image characteristics is provided. The steps of FIG. 1, and optionally additional steps described in subsequent embodiments in the present disclosure, may be repeated continuously with a predefined interval or “refresh rate”.

In a first step 110, the contents of a plurality of image frames is analysed using one or more AI models, such as but not limited to AI Foundation Models (AI FMs), trained on historical data including human eye-tracking data. The images will have been captured by an image capture device of a first user electronic device, which optionally forms part of the exemplary system of the present disclosure. The capturing of image frames may optionally form part of the disclosed method, or image frames may simply be provided to the exemplary software modules by another entity in real time.

In some embodiments, when the user of the first electronic device attempts to access a particular application, sub-feature of the application, piece of content in the application, or a website page in the electronic device interface, the process of FIG. 1 is initiated either automatically or with the user's consent. Where the user's consent is requested, this may take the form of a request for an application to access the image capture device (camera) of the first electronic device. In some embodiments, if the user refuses access to the camera the process may be terminated and the user may be denied access to the content they were to trying to view or open.

The AI model(s) used may include any model that is known in the art and is appropriately configured for image analysis and classification tasks. The AI models may be trained in a supervised fashion with manually or automatically labelled data sets comprising one or more of the characteristics. In addition or alternatively, the AI models may be trained in an unsupervised fashion having been provided with unlabelled data sets comprising one or more of the characteristics. In some embodiments, the AI model(s) may comprise a convolutional neural network (CNN) architecture such as but not limited to ResNet, AlexNet, VGGNet, Inception, Mask R-CNN, and so on. A user interface (UI) may be provided in embodiments of the exemplary system permitting the owner of a website or application using the presently disclosed method to tailor the parameters of the CNN. For example, the UI may be configured to permit the user to adjust the weights of the CNN architecture based on particular eye-tracking characteristics that they are focussed on detecting and analysing in images. Dependent on the particular use-case, the AI model(s) may be deployed remotely with respect to the first electronic device, such as on a cloud services platform, or at the edge on the first electronic device.

Analysing the contents of the plurality of image frames at least comprises identifying one or more characteristics associated with eye-tracking data of a subject in the image frames, and comparing the one or more characteristics with historical data on which the AI model(s) are trained in order to determine a degree of similarity between the characteristic(s) and the historical data. The degree of similarity may be a probability-based confidence level, a tracking score utilising a softmax function, a threshold-based confidence, and so on. The identifying of one or more characteristics by the AI model(s) may involve the model(s) using feature extraction techniques and the like to identify pattern(s) associated with features in the image frames. The step of comparing the one or more characteristics with historical data may involve a comparison of the identified feature patterns with example pattern(s) from the model(s) training data and assessing a degree of similarity. The eye-tracking characteristics assessed by the AI models may include, but are not limited to one or more of: Fixation Duration, a Fixation Count, a Saccade, a Pupil Diameter, a Gaze Path, a heat map, an Area of Interest (AOI), a Latency, a Return Visit, a Pupil Dilation, and/or a Blink Rate. The historical data utilised by the model(s) in their analysis should therefore include one or more of these eye-tracking data types in order to facilitate the comparison. The historical data utilised by the model(s) should therefore also include a mapping of eye-tracking data points to one or more identifying characteristics such as human/not human, and/or age. In some embodiments, the historical data may also include a mapping of eye-tracking data points to a specific, pre-recorded identity of an individual person such as the owner of an electronic device.

By analysing eye-tracking characteristics of the subject in the image frames in accordance with step 110, the exemplary method may determine if the subject is a real human, and/or of a certain age or age range, and/or possessing another identifying characteristics such as ethnicity or gender.

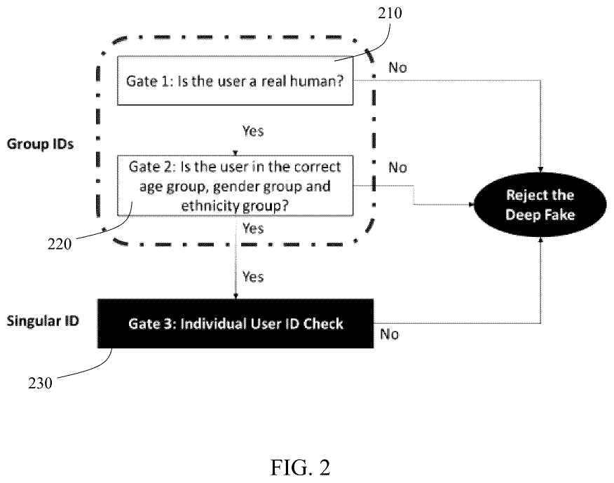

In a further step, the state of the first user electronic device, or a second electronic device, is changed 120 at least in part based on a result of the comparison of the one or more characteristics with the historical data. The result of the comparison will be understood to be a determination that the characteristic(s) are or are not similar with a determined degree of similarity, for example with a False Rejection Rate of less than 0.1% but not limited to that value. By “at least in part”, it is intended to mean that other determining steps may be factored in to the decision to change the state of the device. The inclusion of multiple “gates” in FIG. 2 is one example where multiple iterations of step 110 may be implemented before a change in state 120 is initiated.

The first electronic device is the device which has captured the images, whilst the second electronic device may be a user electronic device that is in engaged in media communication with the first device such as a video call, audio call, media streaming, and the like.

In some embodiments, “changing the state” of the first electronic device comprises implementing one or more protocols in the first electronic device that prevent the user from accessing a particular application or piece of content. This may include, but is not limited to, closing the content that the user has attempted to access, or limiting access to only age-appropriate content corresponding to a determined age of the subject, or closing the application, or reverting to a prior page within the application or webpage. Advantageously, this will prevent users who are either underage or do not have other appropriate permissions to access certain content on the first electronic device from doing so. In other embodiments, “changing the state” of the second user electronic device comprises providing, over a network, a notification at the second electronic device during or after a telecommunications call with the first electronic device that has captured the images. Advantageously, this will allow the user of the second electronic device to be notified if a Deepfake software is being utilised by the user of the first electronic device during their media communication in order to conceal their true identity or particular characteristics of their identity.

The steps 110-120 in FIG. 1 may be repeated with a predefined frequency or “refresh rate” in order to determine if the subject in the image frames has changed. If the determination in step 110 changes, an appropriate change of state of the device may be made. The repeating of steps 110-120 may occur in the background during use of a particular application or webpage on the first electronic device, and preferably involves receiving a periodic feed of new image frames captured in real time with a predefined frequency.

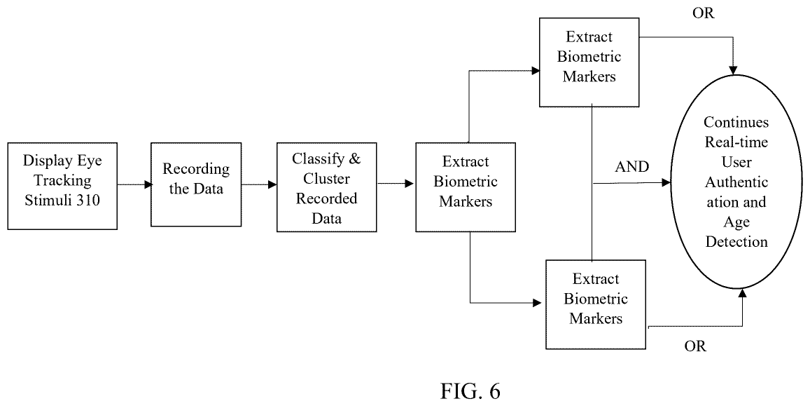

In certain embodiments, the data associated with the analysed, captured image frames can be re-clustered for training the AI model(s) to use in subsequent instances of the exemplary method. Such a continuous training loop may further improve the accuracy of the model over time. An example of this training loop is presented in FIG. 6, but it will be appreciated that this loop is applicable to all embodiments of the present disclosure and is not limited to embodiments involving the provision of visual stimuli.

One or more security “gates” may be defined in relation to the step of analysis 110 in FIG. 1 and subsequent Figures, before the execution of step 120.

FIG. 2 illustrates an example process diagram comprising three gates, although it will be appreciated that fewer or more gates may be implemented. In a first gate 210, the analysis 110 involves determining if the user is a real human based on a comparison the eye-tracking data in the image frames with historical data, regardless of characteristics unique to particular individuals. Although convincing to the naked eye in many cases, computer-generated avatars and humanoid robots fail to replicate most eye-tracking parameters of a real human eye due to the lack of random individual characteristics such as tiredness, individual light sensitivity, etc. If the determination is “no”, then the model concludes that the subject in the image frames is a Deepfake and the process in step 120 of FIG. 1 is initiated to prevent access to content on the device or notify the user of a second device that a Deepfake is being used. Alternatively, if the determination in the first gate 210 is “yes”, then the second gate 220 may be initiated for further testing.

The second gate 220 may comprise determining a first layer of identity characteristics, such as if the user is of a particular age or in a particular age range. The determination of the age group may be motivated by a need to determine if the user is of the appropriate age to access particular content, such as an application page or webpage on their electronic device. In the second gate 220, the age or age range of the subject in the image frames may be determined based on the result of the comparison of the one or more characteristics with the historical data. In these embodiments the historical data may comprise biometric data associated with a given age or age ranges. For example, it has been found that at least some of Fixation Duration, Fixation Count, Saccade, Pupil Diameter, Gaze Path, Latency, Return Visit, Pupil Dilation, and/or Blink Rate may be associated with particular age ranges. As mere examples, it has been found in studies that Fixation Duration is greater in adult subjects compared with children, whilst saccades are found to be shorter in children up until the age of 10-12 and stabilise to adult levels thereafter. In some embodiments, combinations of characteristics may be used by the models to fine tune the age estimation, dependent on the specific data sets on which the models are trained on. The models may cycle through different characteristics to analyse in the subject if the confidence level is below a pre-defined threshold value.

In certain embodiments where the model has prior knowledge of the expected user identity, for example based on application account information or based on identifying information tied to the electronic device, gate 220 may involve the determination of the gender and/or ethnic group of the subject. If the determination is “no” in the second gate 220, then the model concludes that the subject in the image frames is a Deepfake and the process in step 120 of FIG. 1 is initiated to prevent access to content on the device or notify the user of a second device that a Deepfake is being used. Alternatively, if the determination in the second gate 220 is “yes”, then a third gate 230 may be initiated.

The third gate 230 may comprise determining the specific identity of the subject in the image frames. The first two gates 210, 220 are considered to be group identifier (IDs) that can be used for Deepfake crime prevention without accessing sensitive personal data and are thus non-intrusive. The third gate 230 is the only gate that includes the sensitive, unique individual identity of the user.

It will be appreciated that the order of the gates 210-230 can be altered in various embodiments.

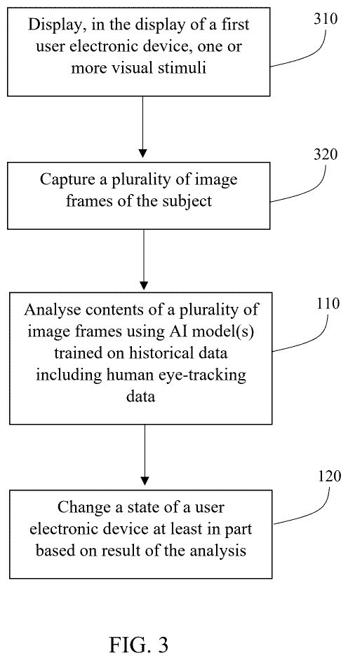

Referring to FIG. 3, the inventors have found that certain visual stimuli comprised of structured and guided lights elicit different oculomotor responses, such as different a Fixation Duration, Fixation Count, Saccade, Pupil Diameter, Gaze Path, Latency, Return Visit, Pupil Dilation, and/or Blink Rate. Moreover, the inventors have found that these oculomotor responses can vary based age. The method in FIG. 3 is substantially similar to FIGS. 1 and 2, but includes initial steps of displaying 310 one or more visual stimuli in the display of the first user electronic device, and capturing 320 a plurality of images of the subject. The eye-tracking characteristic(s) that these visual stimuli elicit can be then be assessed in accordance with the method of FIG. 1. The process in FIG. 3 may serve to further improve accuracy in determining subject identity characteristics such as age, since the measured responses are highly predictable from model training datasets mapping stimuli to eye-tracking characteristics and particular identity characteristics such as age. The visual stimuli utilised may include one or a combination of colours, shapes, light intensities, object motions, temporal or spatial patterns, or contrasts of different objects or colours. The visual stimuli may be displayed for a predefined time period such as but not limited to a time between 10 seconds and 180 seconds. The visual stimuli may comprise one or a plurality of image frames with a predefined frame rate. This data can be captured in a controlled setting beforehand with human subjects representing a variety of different identity characteristics such as age, and the dataset can be provided to the model(s) used in steps 110-120 in a training step which may or may not form part of the exemplary method. The responses to visual stimuli may additionally or alternatively serve as a means for determining if a subject is a real human in step 110 or first gate 210.

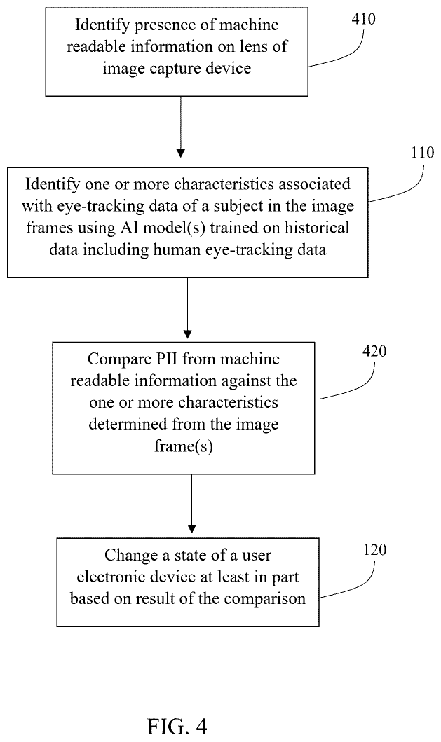

Referring to FIG. 4, in some embodiments micro-scale machine readable information, such as a QR code, a bar code, or the like, may be located on a lens of an image capture device of the first user electronic device as an additional security layer or “gate”. The data encoded by this microscale machine readable information, in combination with the subject's eye tracking biometric data, can be used as an encryption key to lock the first electronic device to a specific user. The image capture device should be suitably configured for a focus distance that is on the scale of the lens diameter. The machine readable information preferably encodes personal identifying information (PII) related to the owner or user of the first electronic device. In various embodiments, the PII may comprise one or more images of a person, or one or more biological characteristics of the person such as eye-tracking biometric data. Compared with the method of any of FIGS. 1-3, the method of FIG. 4 further includes steps of identifying 410 the presence of the machine readable information on the lens of the image capture device, and comparing 420 the encoded PII against the one or more characteristics determined from the image frame(s) in order to determine if the identity of the human subject matches the identity of the person in the PII. Advantageously, the inclusion of PII encoded on the lens of an image capture device of the first user electronic device may prevent an individual who is not the owner of the first electronic device from impersonating the owner of that device in order to access sensitive information such as bank details, passwords, confidential messages, emails, or media, and so on. The method of FIG. 4 provides an example implementation of the third gate 230 in FIG. 2.

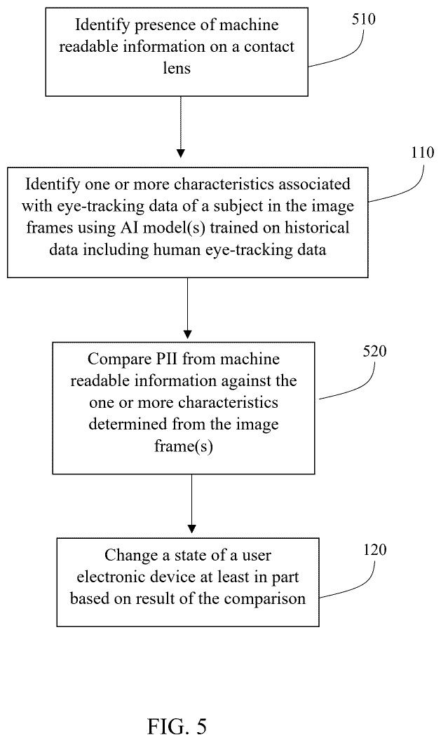

Referring to FIG. 5, the machine readable information encoding PII may alternatively be provided on a contact lens belonging to a human subject. In such a case, the method of any of FIGS. 1-3 may further include steps of identifying 510 the presence of the machine readable information on a contact lens of the subject in the image frames and comparing 520 the encoded PII against the one or more characteristics determined from the image frame(s) in order to determine if the identity of the human subject matches the identity of a person in the PII.

In further embodiments of the present disclosure, the processes of FIGS. 4 and 5 may be combined with each other. That is, machine readable information on the lens of the image capture device can be used in combination with the machine readable information on the contact lens to create a private key to lock the first electronic device to the user who is wearing the contact lens. The AI model(s) can be configured to compare the PII encoded on the contact lens with the PII encoded on the lens of the image capture device in order to determine if the identity of the subject matches the identity of the person associated with the user electronic device. In other embodiments, the processes in FIGS. 4 and 5 may both be combined together with the embodiment of any of FIG. 1-3 to create a 3-layer authentication protocol.

The inventors have found that the readability of machine readable information by software varies dependent on the eye colour of the subject it is set against. Therefore, in some embodiments, the method of FIG. 4 or FIG. 5 may additionally comprise adjusting one or more image enhancement settings in order to enhance detection of machine readable information.

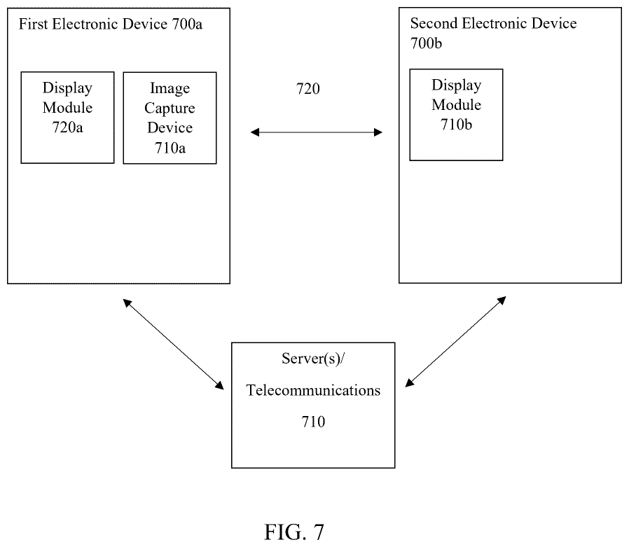

FIG. 7 provides an illustrative example of a system according to embodiments of the present disclosure. The system at least includes the first electronic device 700a having an image capture device 710a and a display module 720a. The system optionally further includes a second electronic device 700b at least having a display module 710b. The first electronic device 700a and the second electronic device 700b may comprise a mobile phone, a tablet, a laptop, a computer, an AR/VR device, a smartwatch, and the like. The first electronic device 700a and the second electronic device 700b may be configured for wireless communication either directly with one another, such as by Bluetooth™, or indirectly over a telecommunications network or an Internet server or similar. In particular, the first electronic device 700a and the second electronic device 700b may be configured to conduct a media communications interaction, such as an audio or video call, with one another. The exemplary method of FIGS. 1-6 may be implemented at the edge on either of the first electronic device 700a and the second electronic device 700b as appropriate, or alternatively may be implemented remotely using a server such as server 710. The image capture device 710a of the first electronic device 700a is configured to capture image frames for analysis 110 by the AI model(s). The display module 710b of the second electronic device 700b is configured to display a notification corresponding to step 120 in FIG. 1. The first electronic device 700a, the second electronic device 700b, and/or the server(s) 710 should each comprise one or more processors configured to carry out the methods disclosed herein such as the methods of FIGS. 1-6 or at least part thereof.

What is claimed is:

1. A computer-implemented method for identification of image characteristics, the method comprising:
analysing contents of a plurality of image frames using one or more artificial intelligence (AI) models trained on historical data including human eye-tracking data, wherein the analysing at least comprises:
identifying one or more characteristics associated with eye-tracking data of a subject in the image frames, and
comparing said one or more characteristics with historical data on which the AI models are trained in order to determine a degree of similarity between the characteristics and the historical data; and
changing a state of a first user electronic device or a second electronic device, at least in part based on a result of the comparison of the one or more characteristics with the historical data.

2. The method of claim 1, further comprising displaying, in the display of the first user electronic device, one or more visual stimuli.

3. The method of claim 1, further comprising capturing, by an image capture device of the first user electronic device, the plurality of image frames.

4. The method of claim 1, comprising capturing, by an image capture device of the first user electronic device, the plurality of image frames, and repeating the steps of capturing and analysing in order to determine if one or more characteristics associated with eye-tracking data of the subject have changed.

5. The method of claim 1, further comprising changing the state of the first user electronic device based on determining that the result of the comparison has changed after repeating.

6. The method of claim 1, wherein changing the state of the first user electronic device comprises preventing access to a software application on the first user electronic device based on the one or more characteristics not matching the historical data to within a pre-defined threshold.

7. The method of claim 1, wherein changing the state of the first user electronic device comprises admitting access to a software application on the first user electronic device based on the one or more characteristics matching the historical data to within a pre-defined threshold.

8. The method of claim 1, wherein the second user electronic device is in media communication with the first electronic device, and wherein changing the state of the second user electronic device comprises providing a notification to the second user electronic device.

9. The method of claim 1, wherein the one or more characteristics comprises a Fixation Duration, a Fixation Count, a Saccade, a Pupil Diameter, a Gaze Path, a heat map, an Area of Interest (AOI), a Latency, a Return Visit, a Pupil Dilation, and/or a Blink Rate.

10. The method of claim 1, wherein data associated with the analysed, captured image frames is provided to the AI models for further training.

11. The method of claim 1, wherein the analysing the contents of at least some of the image frames further comprises a determination of an age or age range of the subject based on the result of the comparison of the one or more characteristics with the historical data.

12. The method of claim 1, wherein the analysing the contents of at least some of the image frames further comprises a determination if the subject matches a pre-recorded identity of a person based on the result of the comparison of the one or more characteristics with the historical data.

13. The method of claim 1, wherein the analysing the contents of at least some of the image frames comprises determining whether or not the subject is a real human based on the result of comparing said one or more characteristic with historical data on which the AI models are trained.

14. The method of claim 3, further comprising:
identifying presence of machine readable information on a lens of the image capture device, wherein the machine readable information encodes personal identifying information (PII).

15. The method of claim 14, wherein comparing the one or more characteristics with historical data comprises comparing the PII against the one or more characteristics determined from the image frames in order to determine if an identity of the human subject matches the identity of a person in the PII.

16. The method of claim 15, wherein the PII comprises one or more biological characteristics of the person.

17. The method of claim 16, wherein the biological characteristics of the person include eye-tracking biometric data associated with the person.

18. The method of claim 1, further comprising:
identifying in the image frames presence of machine readable information on a contact lens worn by the human subject, wherein the machine readable information encodes personal identifying information (PII).

19. The method of claim 16, further comprising comparing the PII against the one or more characteristics determined from the image frames in order to determine if the identity of the human subject matches the identity of the person.

20. The method of claim 12, further comprising adjusting one or more image enhancement settings in order to enhance detection of machine readable information.

21. A computer-implemented method for identification of image characteristics, comprising:
analysing contents of a plurality of image frames using one or more artificial intelligence (AI) models trained on historical data, wherein the analysing at least comprises:
identifying presence of a subject in the image frames,
identifying in the image frames the presence of machine readable information on a contact lens worn by the subject, wherein the machine readable information encodes personal identifying information (PII), and
comparing the PII against an identity record for a person associated with a user electronic device; and
changing a state of the user electronic device based on a result of the comparison of the PII against the identity record for the person associated with the electronic device.

22. A computer-implemented method for identification of image characteristics, comprising:
analysing contents of a plurality of image frames using one or more artificial intelligence (AI) models trained on historical data, wherein the analysing at least comprises:
identifying presence of a subject in the image frames,
identifying in the image frames the presence of machine readable information on a contact lens worn by the subject, wherein the machine readable information encodes personal identifying information (PII),
identifying the presence of machine readable information on a lens of an image capture device, wherein the machine readable information encodes personal identifying information (PII) corresponding to a person associated with a user electronic device, and
comparing the PII encoded on the contact lens with the PII encoded on the lens of the image capture device in order to determine if an identity of the subject matches an identity of the person associated with a user electronic device;
changing a state of the user electronic device based on a result of the comparison of the PII encoded on the contact lens with the PII encoded on the lens of the image capture device.

23. The method of claim 22, further comprising comparing the PII encoded on the contact lens and the PII encoded on the lens of the image capture device with a record of ownership identity for the user electronic device.

24. A non-transitory computer readable storage medium storing instructions thereon, the instructions, when executed by one or more processors, cause the one or more processors to perform the method of claim 1.

25. A system for identification of image characteristics, comprising a user electronic device comprising an image capture device configured for capturing image frames, and one or more processors configured to perform the method of claim 1.
